(19) United States
(12) Patent Application Publication
(10) Pub. No.: US 2004/0025291 A1
(43) Pub. Date: Feb. 12, 2004

(54) Fixing structure for blind brackets and blind rod

(75) Inventor: Sandy Yu, Ho-Mei (TW)

Correspondence Address: BACON & THOMAS, PLLC, 4th Floor, 625 Slaters Lane, Alexandria, VA, 22314-1176, US

(73) Assignee: PIINC HEH ENTERPRISE CO., LTD., Changhua (TW)

(21) Appl. No.: 10/214,647

(22) Filed: Aug. 9, 2002

(51) Int. Cl. E05D 15/00

(52) U.S. Cl. 16/87 R

(57) ABSTRACT

Fixing structure for blind brackets and blind rod, including two blind brackets, a blind rod and two coiled resilient bodies. One side of each blind bracket is locked with a base seat. The other side of the blind bracket is formed with a locating recess. A lateral wall face of the locating recess is formed with a guide slide face with a certain inclination. The other lateral wall face of the locating recess is formed with an arched attaching face adapted to the outer diameter of the blind rod. A middle portion of the guide slide face is formed with a longitudinal arched fitting channel with a certain depth. The fitting channel is adapted to the coiled resilient body for the coiled resilient body to fit and locate therein. When assembled or detached, a user only needs to downward press the blind rod along the guide slide faces to fixedly fit the blind rod into the locating recesses or upward push the blind rod out of the locating recesses. Therefore, without using any tool, a user can quickly and conveniently assemble or detach the blind rod for replacement of the blind.

### BACKGROUND OF THE INVENTION

The present invention is related to a fixing structure for blind brackets and blind rod. The blind bracket is formed with a locating recess. A coiled resilient body is fitted in the locating recess. When assembled or detached, a user only needs to downward press the blind rod to fixedly fit the blind rod into the locating recesses or upward push the blind rod out of the locating recesses. Therefore, without using any tool, a user can quickly and conveniently assemble or detach the blind rod for replacement of the blind. In addition, the blind brackets and the blind rod are free from any thread hole so that the processing procedure is simplified and the cost is saved.

FIG. 1 shows a conventional blind bracket structure including two blind brackets 10, a blind rod 20 and two screws 30. One side of each blind bracket 10 is formed with a semicircular recess 11. The bottom of the semicircular recess 11 is formed with a thread hole 12. Two sides of the blind rod 20 are formed with thread holes 21. When assembled, the blind is fitted on the blind rod 20. Two sides of the blind rod 20 are fitted in the semicircular recesses 11 of the blind brackets 10 with the thread holes 12, 21 aligned with each other. Two screws 30 are screwed into the thread holes 12, 21 to fix the blind rod 20 with the blind brackets 10. Then the blind brackets 10 are locked on a wall face.

The above structure has some shortcomings as follows:

1. The blind brackets 10 and the blind rod 20 are formed with thread holes 12, 21 for the screws to fix the blind rod with the blind bracket. The processing cost is higher.

2. When detaching and replacing the blind, a user needs to first unscrew the screws 30 with a tool and then replace the blind. After replacement, it is necessary to align the thread holes 21 of the blind rod 20 with the thread holes 11 of the blind brackets 10 and then screw the screws into the thread holes. Such assembling procedure is inconvenient and troublesome.

FIG. 2 shows another type of conventional blind bracket structure including two blind brackets 40, a blind rod 20 and two screws 30. One side of each blind bracket 40 is locked with a base seat 41. The other side of the blind bracket 40 is formed with a through hole 42. The upper side of the through hole 42 is formed with a thread hole 43 communicating with the through hole 43. Two sides of the blind rod 20 are formed with thread holes 21. When assembled, the blind is fitted on the blind rod 20 and then two sides of the blind rod 20 are respectively fitted into the through holes 42 of the blind brackets 40 with the thread holes 43, 21 aligned with each other. Then the screws 30 are screwed into the thread holes 43, 21 to fix the blind rod 20 with the blind brackets 40. Then the base seats 41 of the blind brackets 40 are locked on a wall face.

The above structure has some shortcomings as follows:

1. The blind brackets 40 and the blind rod 20 are formed with thread holes 43, 21 for the screws to fix the blind rod with the blind bracket. The processing procedure is complicated and the processing cost is higher.

2. When detaching and replacing the blind, a user needs to first unscrew the screws 30 with a tool and then replace the blind. After replacement, it is necessary to align the thread holes 21 of the blind rod 20 with the thread holes 43 of the blind brackets 40 and then screw the screws into the thread holes. Such assembling procedure is inconvenient and troublesome.

FIG. 3 shows still another type of conventional blind bracket structure including two blind brackets 80, a blind rod 20 and two screws 30. One side of each blind bracket 80 is locked with a base seat. The other side of the blind bracket 80 is formed with an arched fitting recess 81. The center of the fitting recess 81 is formed with a thread hole 82. Two sides of the blind rod 20 are formed with thread holes 21. When assembled, the blind is fitted on the blind rod 20 and then two sides of the blind rod 20 are respectively fitted into the fitting recesses 81 of the blind brackets 80 with the thread holes 82, 21 aligned with each other. Then the screws 30 are screwed into the thread holes to fix the blind rod 20 with the blind brackets 80. Then the base seats of the blind brackets 80 are locked on a wall face.

The above structure has some shortcomings as follows:

1. The blind brackets 80 and the blind rod 20 are formed with thread holes 82, 21 for the screws to fix the blind rod with the blind bracket. The processing procedure is complicated and the processing cost is higher.

2. When detaching and replacing the blind, a user needs to first unscrew the screws 30 with a tool and then replace the blind. After replacement, it is necessary to align the thread holes 21 of the blind rod 20 with the thread holes 82 of the blind brackets 80 and then screw the screws into the thread holes. Such assembling procedure is inconvenient and troublesome.

### SUMMARY OF THE INVENTION

It is therefore a primary object of the present invention to provide a fixing structure for blind brackets and blind rod. The blind bracket is formed with a locating recess. A coiled resilient body is fitted in the locating recess. When assembled or detached, a user only needs to downward press the blind rod to fixedly fit the blind rod into the locating recesses or upward push the blind rod out of the locating recesses. Therefore, without using any tool, a user can quickly and conveniently assemble or detach the blind rod for replacement of the blind.

It is a further object of the present invention to provide the above fixing structure in which the blind brackets and the blind rod are free from any thread hole so that the processing procedure is simplified and the cost is saved.

It is still a further object of the present invention to provide the above fixing structure in which one side of the blind bracket is formed with several locating recesses. One or more blind rod can be selectively fitted into the locating recesses as desired. The blinds with different thickness of color can be fitted on the blind rods from front side to rear side and overlap each other to present various visual effect.

It is still a further object of the present invention to provide the above fixing structure in which the blind bracket is horizontally locked on a wall face or locked on a wall face in a suspending state. In suspending state, a user can also quickly and conveniently assemble the blind rod with the blind brackets without possibility of dropping.

The present invention can be best understood through the following description and accompanying drawings wherein:

### BRIEF DESCRIPTION OF THE DRAWINGS

FIG. 1 is a perspective assembled view of a conventional fixing structure for blind brackets and blind rod;

FIG. 2 is a perspective assembled view of another type of conventional fixing structure for blind brackets and blind rod;

FIG. 3 is a perspective assembled view of still another type of conventional fixing structure for blind brackets and blind rod;

FIG. 4 is a perspective exploded view of the fixing structure for blind brackets and blind rod of the present invention;

FIG. 5 is a sectional assembled view of the fixing structure for blind brackets and blind rod of the present invention;

FIG. 6 is a perspective assembled view of another embodiment of the fixing structure for blind brackets and blind rod of the present invention; and

FIG. 7 is a perspective assembled view of still another embodiment of the fixing structure for blind brackets and blind rod of the present invention, in which the blind bracket is locked in a suspending state.

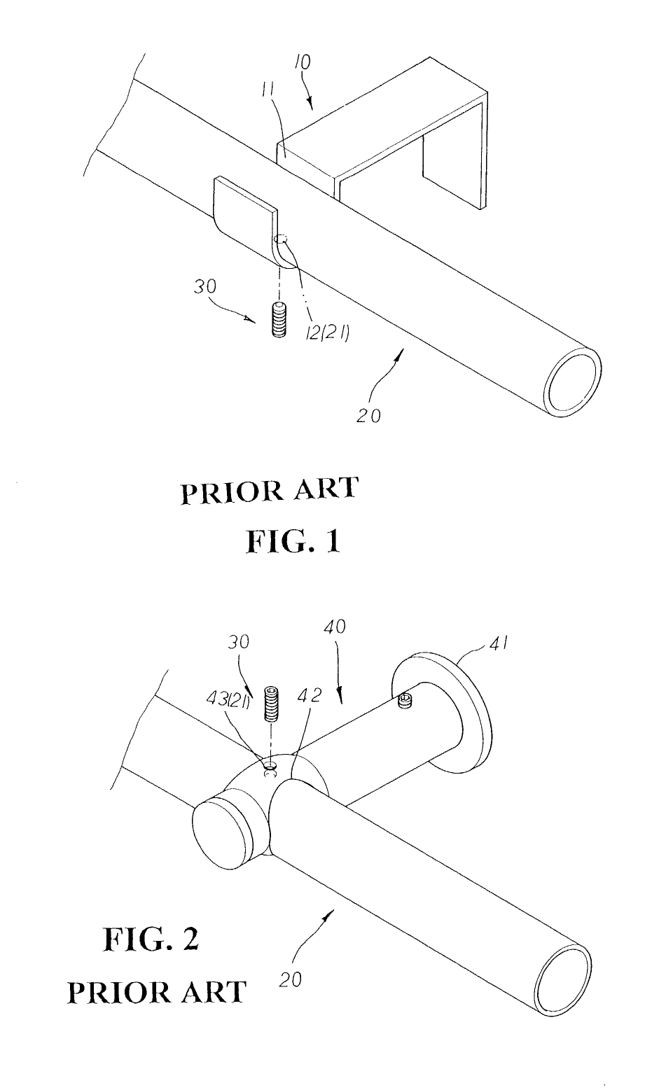

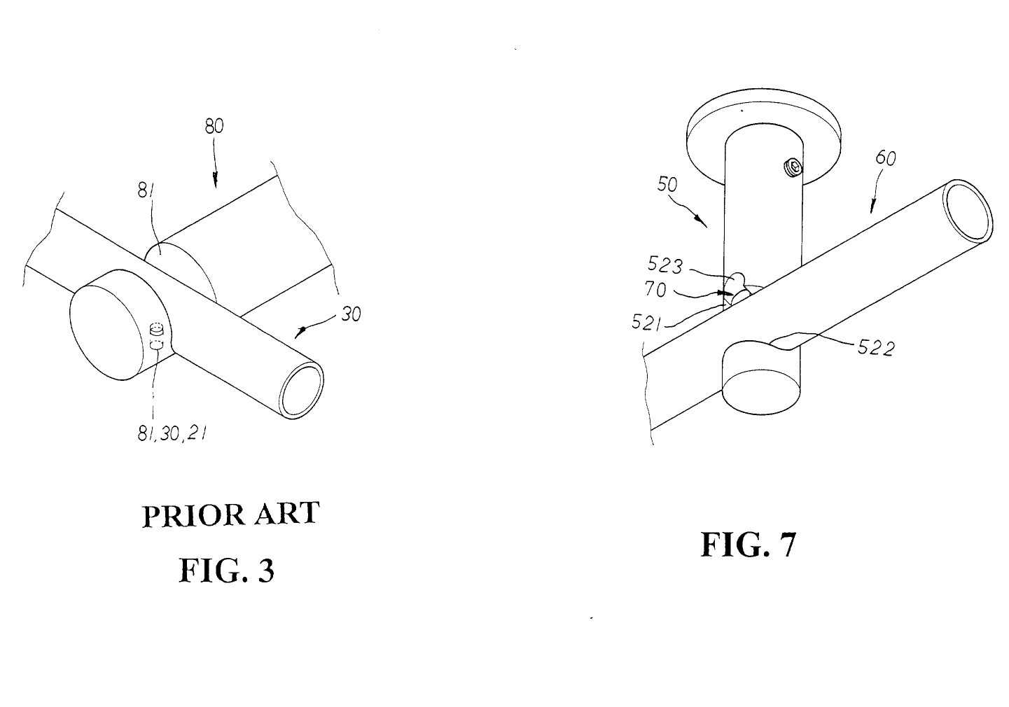

### DETAILED DESCRIPTION OF THE PREFERRED EMBODIMENTS

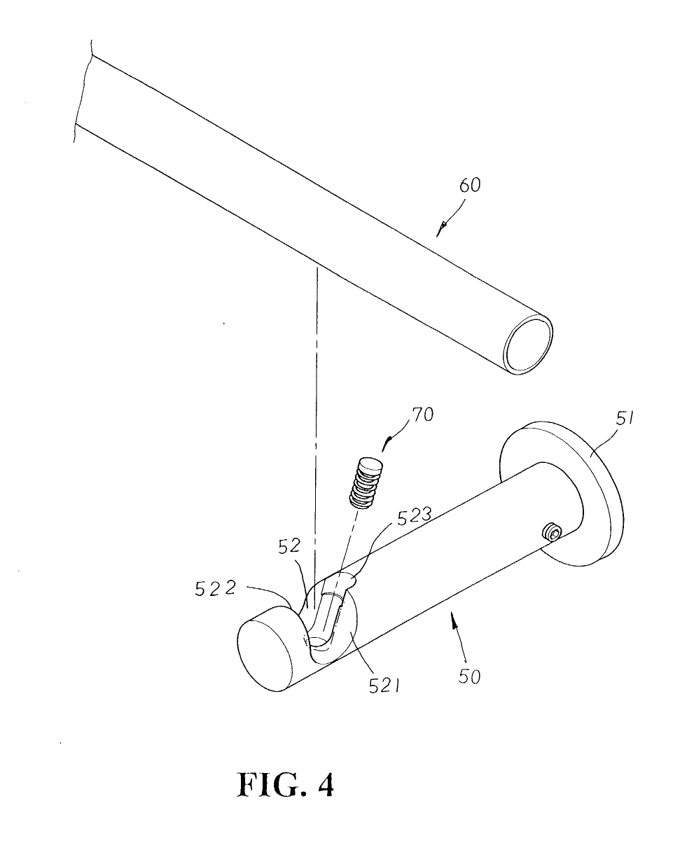

Please refer to FIG. 4. The present invention includes two blind brackets 50, a blind rod 60 and two coiled resilient bodies 70. One side of the blind bracket 50 is locked with a base seat 51. The other side of the blind bracket 50 is formed with a locating recess 52. A lateral wall face of the locating recess 52 is formed with a guide slide face 521 with a certain inclination. The other lateral wall face of the locating recess 52 is formed with an arched attaching face 522 adapted to the outer diameter of the hollow blind rod 60. The middle of the guide slide face 521 is formed with a longitudinal arched fitting channel 523 with a certain depth. The fitting channel 523 is adapted to the coiled resilient body 70.

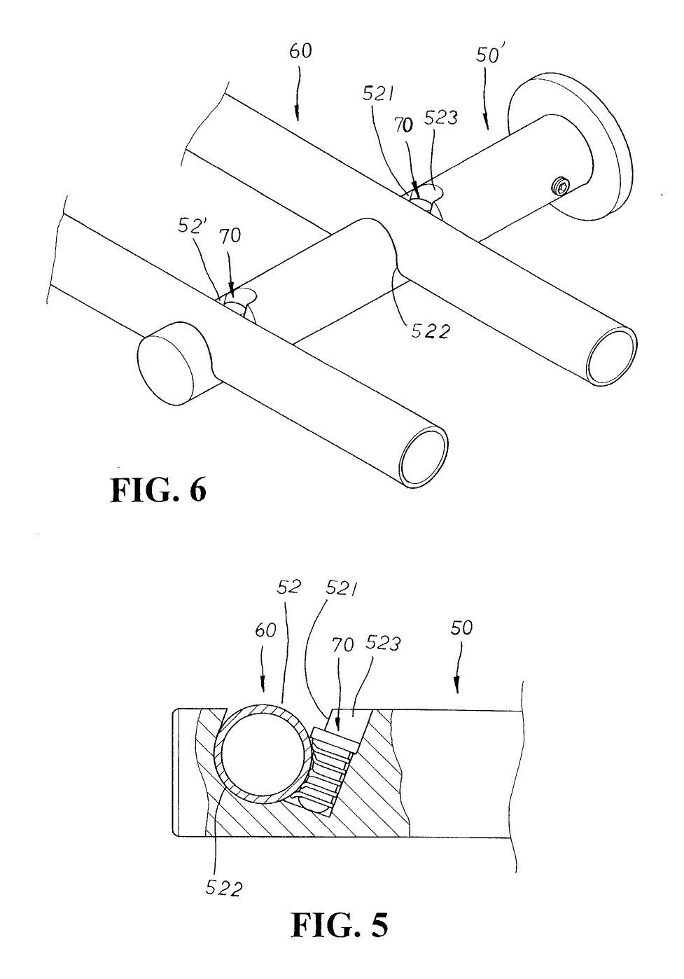

When assembled, referring to FIG. 5, the two coiled resilient bodies 70 are respectively tightly fitted into the arched fitting channels 523 of the blind brackets 50. Then the base seats 51 of the blind brackets 50 are locked on a wall face. After the blind is fitted onto the blind rod 60, the blind rod 60 is downward pressed to slide into the locating recesses 52 along the guide slide faces 521. At this time, the blind rod 60 is resiliently compressed by the coiled resilient bodies 70 to tightly abut against the attaching faces 522. Under such circumstance, the blind rod 60 is firmly fixed in the locating recesses 52 to complete the assembly.

When detaching and replacing the blind, a user only needs to upward push the blind rod 60 along the guide slide faces 521 to make the blind rod 60 detach out from the locating recesses 52. After replacement, the user only needs to downward press the blind rod 60 into the locating recesses 52 along the guide slide faces 521. Therefore, without using any tool, a user can conveniently complete the assembling and detaching procedure.

FIG. 6 is another embodiment of the present invention, in which one side of the blind bracket 50′ is formed with several locating recesses 52′ at equal intervals. One or more blind rod 60 can be selectively fitted into the locating recesses 52′, whereby the blinds with different thickness of color can be fitted on the blind rods 60 from front side to rear side and overlap each other to present various visual effect.

FIG. 7 shows still another embodiment of the present invention, in which the blind brackets 50 are locked on a wall face in a suspending state. A user can also quickly and conveniently assemble the blind rod 60 with the blind brackets 50 without possibility of dropping.

The above embodiments are only used to illustrate the present invention, not intended to limit the scope thereof. Many modifications of the above embodiments can be made without departing from the spirit of the present invention.

What is claimed is:

1. Fixing structure for blind brackets and blind rod, comprising two blind brackets, a blind rod and two coiled resilient bodies, one side of each blind bracket being locked with a base seat, the blind bracket being horizontally locked on a wall face or locked on a wall face in a suspending state, said fixing structure being characterized in that the other side of the blind bracket is formed with a locating recess, a lateral wall face of the locating recess being formed with a guide slide face with a certain inclination, the other lateral wall face of the locating recess being formed with an arched attaching face adapted to the outer diameter of the blind rod, a middle portion of the guide slide face being formed with a longitudinal arched fitting channel with a certain depth, the fitting channel being adapted to the coiled resilient body for the coiled resilient body to fit and locate therein, whereby when assembled, the blind rod is downward pressed to slide into the locating recesses along the guide slide faces and the blind rod is resiliently compressed by the coiled resilient bodies to tightly abut against the attaching faces, whereby the blind rod is firmly fixed in the locating recesses, and when detaching and replacing the blind, a user only needs to upward push (downward press) the blind rod along the guide slide faces to make the blind rod detach out from (fixedly fit into) the locating recesses, without using any tool, a user being able to quickly and conveniently assemble and detach the blind rod.

2. Fixing structure for blind brackets and blind rod as claimed in claim 1, wherein one side of the blind bracket is formed with several locating recesses at equal intervals, whereby one or more blind rod can be selectively fitted into the locating recesses as desired so that blinds with different thickness of color can be fitted on the blind rods from front side to rear side and overlap each other to present various visual effect.
